(19) United States
(12) Patent Application Publication
(10) Pub. No.: US 2012/0039018 A1
(43) Pub. Date: Feb. 16, 2012

(54) Device for Discharging an Explosive Gas

(76) Inventors: Tilman Diesselhorst, Munchen (DE); Miks Hartmann, Erlangen (DE); Dirk Knief, Mulheim an der Ruhr (DE)

(21) Appl. No.: 13/202,122

(22) PCT Filed: Feb. 19, 2010
(86) PCT No.: PCT/EP2010/052155

§ 371 Date: Oct. 18, 2011

(30) Foreign Application Priority Data
Feb. 24, 2009 (EP) 09002576.8

(51) Int. Cl. H01G 9/00

(52) U.S. Cl. 361/500

(57) ABSTRACT

A device for releasing an explosive gas via a stack arranged on a roof of a building is provided. The upper free end of the stack is provided with a discharging head including a plurality of distribution pipes projecting from the stack in the form of a star. Each pipe includes an outlet on the free end thereof. The device reduces the pressure wave load exerted during an explosion even during adverse wind conditions. To this end, the end regions of the distribution pipes are embodied as jet pumps in which the explosive gas is the propellant sucking the ambient air.

### CROSS REFERENCE TO RELATED APPLICATIONS

This application is the US National Stage of International Application No. PCT/EP2010/052155, filed Feb. 19, 2010 and claims the benefit thereof. The International Application claims the benefits of European Patent Office application No. 09002576.8 EP filed Feb. 24, 2009. All of the applications are incorporated by reference herein in their entirety.

### FIELD OF INVENTION

The present invention relates to a device for discharging an explosive gas via a stack that is arranged on a roof of a building and on whose upper free end there is provided a discharging head that consists of a plurality of distributor pipes emanating in a star shape fashion from the stack and which are respectively provided at their free end with an exit opening.

### BACKGROUND OF INVENTION

Large generators in power plants are cooled with hydrogen as a rule. In the event of malfunctions, this hydrogen must be removed from the generators as rapidly as possible. This rapid emptying is performed by discharging the hydrogen into the atmosphere via the roof of the power house. Since hydrogen is an explosive gas, there is the risk of a detonating gas explosion upon exit into the atmosphere and upon mixing with the atmospheric oxygen. The pressure wave propagating from the ignition location above the discharging device can cause damage to the roof of the power house in which the generators are located.

Devices of the type mentioned at the beginning are provided in order largely to reduce this pressure wave loading. Such a device for discharging an explosive gas is described in DE 195 17 163 A1, for example.

In this known arrangement, the exiting gas is separated into a number of gas jets corresponding to the number of the exit openings; said gas jets are separated from one another spatially, at least in the ignitable volume regions thereof. The gas jets can therefore not ignite together, and so the pressure wave occurring from an explosion is of smaller amplitude.

However, this does not hold in the case of strong wind conditions. Given strong wind conditions, the ignitable volume regions separated spatially from one another can be blown together again to form a single large ignitable volume region.

### SUMMARY OF INVENTION

It is an object of the present invention to specify a device of the type mentioned at the beginning in the case of which the pressure wave loading exerted in the event of an explosion is reduced even given adverse weather conditions.

This object is achieved according to the invention in the case of the device mentioned at the beginning by virtue of the fact that the end regions of the distributor pipes are designed as jet pumps in which the explosive gas is the motive medium that takes in the ambient air.

In the inventive device, the mean density in the discharged jet is increased, thus giving rise to a larger jet impulse. The increase in the mean density is a consequence of the fact that air is approximately ten times as dense as hydrogen. In this way, the ignitable volumes are reduced and as a consequence of the large jet impulse no large deflection occurs when the wind is strong.

### BRIEF DESCRIPTION OF THE DRAWINGS

Further expedient refinements of the present invention emerge from the subclaims and from the following description of an exemplary embodiment with the aid of the attached drawing, in which:

FIG. 1 shows a schematic side view of an inventive device for discharging an explosive gas,

FIG. 2 shows a plan view of the device illustrated in FIG. 1, and

FIG. 3 shows a longitudinal section through a jet pump of the inventive device.

### DETAILED DESCRIPTION OF INVENTION

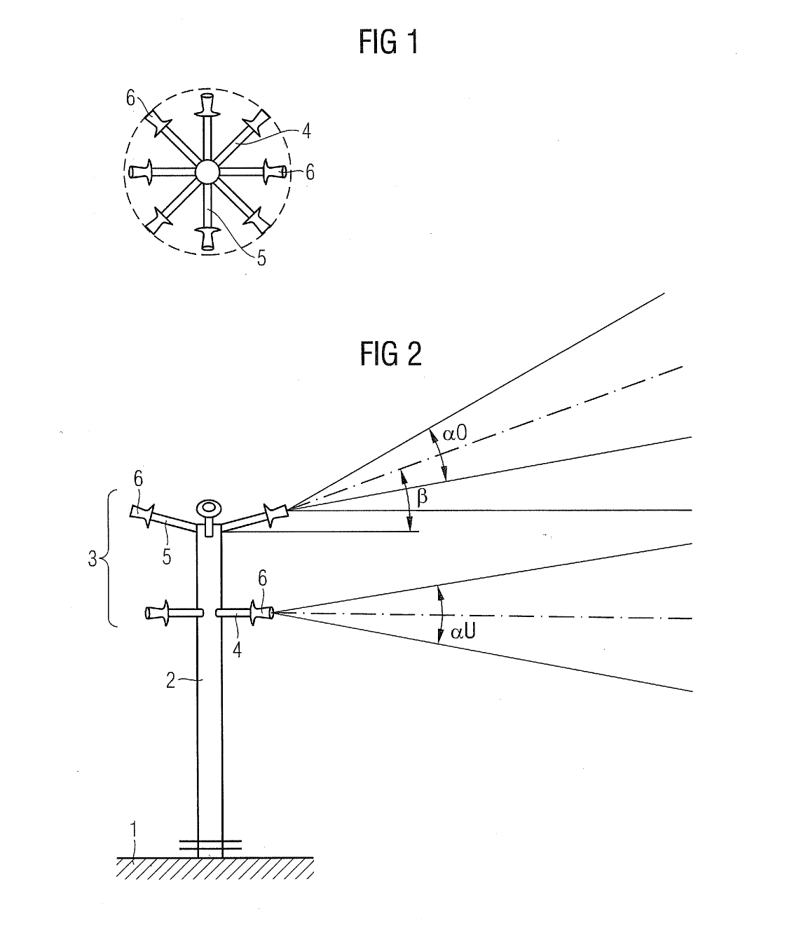

FIG. 1 shows a side view of an inventive device for discharging an explosive gas that substantially comprises a stack 2 and a discharging head 3, the stack being mounted on a roof 1.

In the inventive device, the discharging head 3 is designed such that the distributor pipes are split into two levels. The distributor pipes 4 are located in the lower level, and the distributor pipes 5 are located in the upper level.

In order to achieve a yet greater separation of the explosive mixed gas jets blown out, the distributor pipes of the upper level are inclined upward at a prescribed angle, while the distributor pipes 4 and 5 are arranged in an alternating fashion.

In accordance with the invention, a jet pump 6 is respectively located at the end of the distributor pipes.

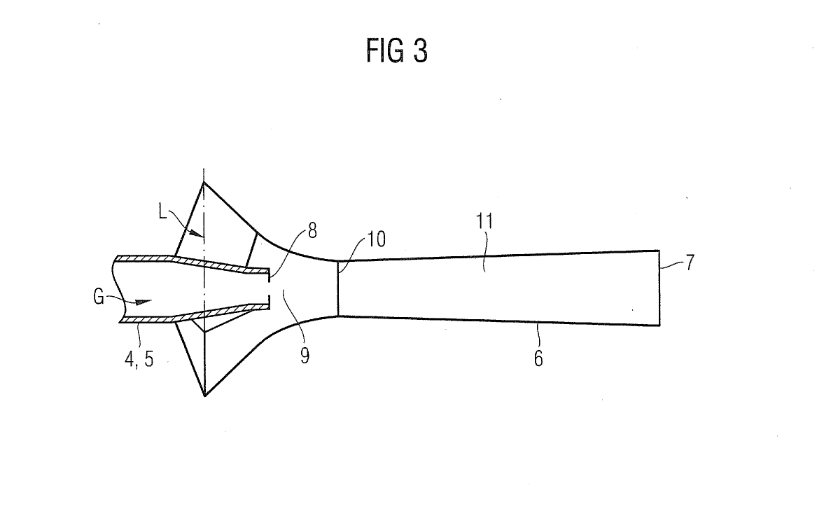

The design of the jet pump 6 is illustrated schematically in FIG. 3.

The respective distributor pipe, via which the hydrogen gas G is fed is illustrated at 4, 5. The driving nozzle 8 is located on the end of the respective distributor pipe. In the mixing chamber 9 situated therebefore, the air is sucked in owing to the underpressure set up in the diffuser neck. The gas is mixed substantially in the diffuser 11 with the intake air as far as the exit opening 7, through which it is blown out.

αo and αu respectively mark the emission angles of the air/gas mixture. β marks the angle of inclination of the upper distributor pipes 5. It is clearly to be seen from FIG. 1 that the inclination of the upper distributor pipes 5 upward by a prescribed angle yet further separates from one another the ignitable volumes that are located within the emission angles.

1-4. (canceled)

5. A device for discharging an explosive gas, comprising:
a stack that is arranged on a roof of a building; and
a discharging head that comprises a plurality of distributor pipes emanating in a star shape from the stack,
wherein the discharging head is provided on an upper free end of the stack, and
wherein the plurality of distributor pipes each include at a free end an exit opening, and
wherein an end region of each of the plurality of distributor pipes is designed as a jet pump in which the explosive gas is a motive medium that takes in ambient air.

6. The device as claimed in claim 5, wherein the plurality of distributor pipes are arranged in two levels.

7. The device as claimed in claim 5, wherein the plurality of distributor pipes are arranged in a fashion circulating alternately in the lower and upper level.

8. The device as claimed in claim 5, wherein the plurality of distributor pipes of the upper level are inclined upward at a prescribed angle.

9. The device as claimed in claim 5,
wherein each distributor pipe includes a driving nozzle disposed in the end region of the distributor pipe and a mixing chamber adjacent to the nozzle where air is sucked in,
wherein the intake air is mixed with the explosive gas in a diffuser disposed after the mixing chamber in a flow direction, and
wherein the mixture is blown out of the exit opening.
